(19) United States
(12) Patent Application Publication
(10) Pub. No.: US 2008/0074343 A1
(43) Pub. Date: Mar. 27, 2008

(54) Digital Video Switch and Method of Switching Between Multiple Digital Video Inputs and Multiple Outputs

(75) Inventors: Carey Sasser, Bloomingdale, IL (US); Dave Tynis, Carpentersville, IL (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Medical solutions USA, Inc., Malvern, PA (US)

(21) Appl. No.: 11/672,586

(22) Filed: Feb. 8, 2007

Related U.S. Application Data
(60) Provisional application No. 60/847,264, filed on Sep. 26, 2006.

(51) Int. Cl. G09G 5/00

(52) U.S. Cl. 345/1.1

(57) ABSTRACT

A system and method to connect multiple digital visual interface sources (DVI) from one or multiple computers to any combination of multiple monitors that can be controlled through USB or manual selection. A video signal switching apparatus and circuitry, including an electronic crosspoint switch, enables switching very high speed video signals. The device can also be used to enable video signals from multiple computers with digital video interfaces to be displayed on multiple display devices.

### CROSS-REFERENCE TO RELATED APPLICATIONS

This application claims a priority benefit to provisional application Ser. No. 60/847,264, filed on Sep. 26, 2006 and entitled “Digital Video Crosspoint Switch,” which is hereby incorporated by reference in its entirety herein.

### BACKGROUND

1. Field of the Invention

This invention relates generally to providing digital video data to a plurality of display devices. More specifically, the present invention is directed to a digital video crosspoint switch that can receive multiple digital video inputs and provide the digital video data to multiple display devices.

2. Background Discussion

In video display systems, incoming video data may be controlled by a switching mechanism.

However, conventional switching techniques only enable connection between one digital video source and multiple monitors, or multiple digital video sources to a single monitor.

Thus, conventional switching devices and techniques do not adequately provide digital video data from multiple sources to multiple display devices.

Therefore, it would be an advancement in the state of the art to provide a system and method for supplying digital video signals from a plurality of video sources to a plurality of display devices.

### SUMMARY

Thus, an embodiment of the present invention is directed to a crosspoint, or crossbar, switch that has the ability to connect multiple digital video sources from one or multiple computers to any combination of multiple monitors, controlled through a Universal Serial Bus (USB) or manual selection.

The crosspoint switch in accordance with an embodiment of the present invention enables switching very high speed video signals. An embodiment of present invention can be used to enable video signals from multiple computers with digital video interfaces to be displayed simultaneously on multiple display devices.

Accordingly, one embodiment of the present invention is directed to an apparatus for providing multiple digital video sources from one or multiple computers, or sources, to any combination of multiple monitors, controlled through a universal serial bus (USB) or manual selection. This apparatus (hereinafter, “the apparatus”) includes a plurality of input modules adapted to receive digital video data. A control module generates control signals. A switching module receives the digital video data from the plurality of input modules and also receives the control signals from the control module. The switching module outputs digital video data signals to a plurality of display modules that display digital video data as a function of the output digital video signals from the switching module.

Another embodiment of the present invention is directed to the apparatus described above, wherein the control module is a microcontroller, specifically a USB microcontroller.

Yet another embodiment of the present invention is directed to the apparatus described above and enables connection of one or more digital video data sources to one or more monitors.

Yet another embodiment of the present invention is directed to the apparatus described above and further includes several I²C serial buses coupled to the microcontroller and to each other through an I²C switch.

Yet another embodiment of the present invention is directed to the apparatus described above wherein the microcontroller generates video enable signals and provides the video enable signals to selected display modules.

Yet another embodiment of the present invention is directed to the apparatus described above, wherein the control module is a switch selection module, such as switch selection jumpers, an external switch, push buttons, or a rotary switch.

Yet another embodiment of the present invention is directed to the apparatus described above, wherein selected digital video data is transmitted to any permutation of the display modules.

Yet another embodiment of the present invention is directed to the apparatus described above, wherein the control module comprises switch selection jumpers, an external switch, push buttons, or a rotary switch, in addition to the USB microcontroller.

Another embodiment of the present invention is directed to a method (hereinafter, “the method”) for providing multiple digital visual interface sources (DVI) from one or multiple computers to any combination of multiple monitors, controlled through a USB or manual selection.

Yet another embodiment of the present invention is directed to the method described above, which includes providing two or more input modules adapted to receive digital video data, connecting these modules to a switching module adapted to receive the digital video data. Control signals are generated and transmitted to the switching module, which is adapted to receive the digital video data from the two or more input modules and the control signals from the control module. The switching module selects digital video data signals based on the control signals and provides the selected digital video data signals to selected display modules. The digital video data is displayed simultaneously on one or more display modules as a function of the switching signals.

Other embodiments of the present invention include the methods described above but implemented using apparatus and programmed as computer code to be executed by one or more processors operating in conjunction with one or more electronic media.

### BRIEF DESCRIPTION OF THE DRAWINGS

To the accomplishment of the foregoing and related ends, certain illustrative aspects of the invention are described herein in connection with the following description and the annexed drawings. These aspects are indicative, however, of but a few of the various ways in which the principles of the invention may be employed and the present invention is intended to include all such aspects and their equivalents. Other advantages and novel features of the invention may become apparent from the following description of the invention when considered in conjunction with the drawings. The following description, given by way of example, but not intended to limit the invention solely to the specific embodiments described, may best be understood in conjunction with the accompanying drawings, in which:

FIG. 1 shows a block diagram of an embodiment of the present invention;

FIG. 2 illustrates an apparatus according to one embodiment of the present invention;

FIG. 3 illustrates an apparatus according to another embodiment of the present invention; and

FIG. 4 illustrates an apparatus according to yet another embodiment of the present invention.

### DETAILED DESCRIPTION

It is noted that in this disclosure and particularly in the claims and/or paragraphs, terms such as “comprises,” “comprised,” “comprising,” and the like can have the meaning attributed to it in U.S. patent law; that is, they can mean “includes,” “included,” “including,” “including, but not limited to” and the like, and allow for elements not explicitly recited. Terms such as “consisting essentially of” and “consists essentially of” have the meaning ascribed to them in U.S. patent law; that is, they allow for elements not explicitly recited, but exclude elements that are found in the prior art or that affect a basic or novel characteristic of the invention. These and other embodiments are disclosed or are apparent from and encompassed by, the following description. As used in this application, the terms “component” and “system” are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

One application of an embodiment of the present invention is in a hospital angiography lab where monitors, or display devices, are located in an examination room where a doctor performs medical procedures and display devices are also located in the control room where technicians assist the doctor. The display devices in both of these locations need to be able to display video data from two different sources, where the video data usually includes a reference image and a live image. An embodiment of the invention reduces the total amount of monitors needed and thus provides for an efficient and economical viewing system.

Generally, an embodiment of the present invention relates to video signal switching apparatus and circuitry, and in particular to electronic crosspoint switch circuitry and devices for switching very high speed video signals. An embodiment of the invention can be used to enable video signals from multiple computers with digital video interfaces to be displayed on multiple display devices. The digital video data can be displayed on the multiple display devices simultaneously. It is also an embodiment that analog video signals could be used. In this embodiment, analog video converters that convert analog video data to digital video data may be used. A VGA to DVI conversion box may be used to connect an analog video graphic cards (VGA) to DVI compliant digital monitors.

More specifically, an embodiment of the present invention provides for a system and method having the ability to connect multiple digital visual interface sources (DVI) from one or multiple computers, or digital video data sources, to any combination of multiple monitors and is controlled through USB or manual selection, or a combination of USB and manual selection.

A monitor, or display device, or display module, which is typically coupled to a computer or other processing device, provides an interface (the hardware implementation is a standard referred to as I²C) in order to communicate with an EEPROM in the monitor (the protocol is referred to as DDC) so that the monitors capabilities can be determined (such as supported resolutions) and to provide diagnostic capabilities. This interface exists within the digital visual interface (DVI) cable along with the digital video. More particularly, the I²C bus is part of the DVI connector along with the digital video. The I²C bus is used by the graphics card of the monitor device to query, for example, an EEPROM in the monitor device in order to determine its capabilities. Since normally the connection is a graphics card to a monitor, a problem occurs when there are several monitors. The I²C bus may be connected to one monitor or the on board EEPROM may be provided, which provides the same information. The microcontroller has the capability to read the EEPROM in the monitor and store those contents in the EEPROM on board.

An embodiment of the present invention provides a shadow DDC EEPROM for each input. These shadow DDC EEPROMs contain the same information that exist in the monitors' DDC EEPROMs and when each input reads the DDC EEPROM, it reads the shadow EEPROM instead of the monitors' EEPROM. The USB microcontroller provides the ability to copy the information from the DDC EEPROM of any of the connected monitors into these shadow DDC EEPROMS. This is the normal mode of operation whenever two inputs are connected to any number of monitors.

If only one input is connected, the shadow DDC EEPROM is not necessary (but can still be used) and an embodiment of the invention provides the ability to directly connect the I²C interface of the input to one of the monitors (the remaining monitors must still have the same display capabilities).

An embodiment of the invention also provides the ability (using an I²C switch) to connect any input I²C interface to any monitor (one input at a time). This allows communication with any monitor from either input such as in the case where diagnostics need to be performed. This is also used to connect specific I²C interfaces to allow reading a monitor DDC EEPROM and writing the shadow DDC EEPROM.

An embodiment of the present invention provides control of video switching via USB or manual selection, or combination of the two, to enable or disable the video output, and provides connecting interfaces, such as I²C interfaces, of the inputs to the monitors, that may be coupled to computers or other processing terminals, through an I²C switch or via a direct connection from one input to one output. An I²C switch, such as a Philips®' PCA954x I²C switch, may be used to allow voltage level shifting between devices operating at 5.0, 3.3, 2.5 or 1.8V, for example, at serial clock frequencies up to 400 kHz. The I²C switch also provides multiplexing and interrupt controlling to eliminate the need for glue logic and general purpose input/output (I/O).

An embodiment of the present invention comprises a system and method for providing multiple digital video sources (such as from DVI) from one or multiple computers, or sources, to any combination of multiple monitors, controlled through a USB or manual selection. This apparatus (hereinafter, “the apparatus”) includes two or more input modules adapted to receive digital video data and a control module that generates control signals. A switching module receives the control signals from the control module and outputs digital video data to one or more display modules. The display modules display the digital video data as a function of the output signals.

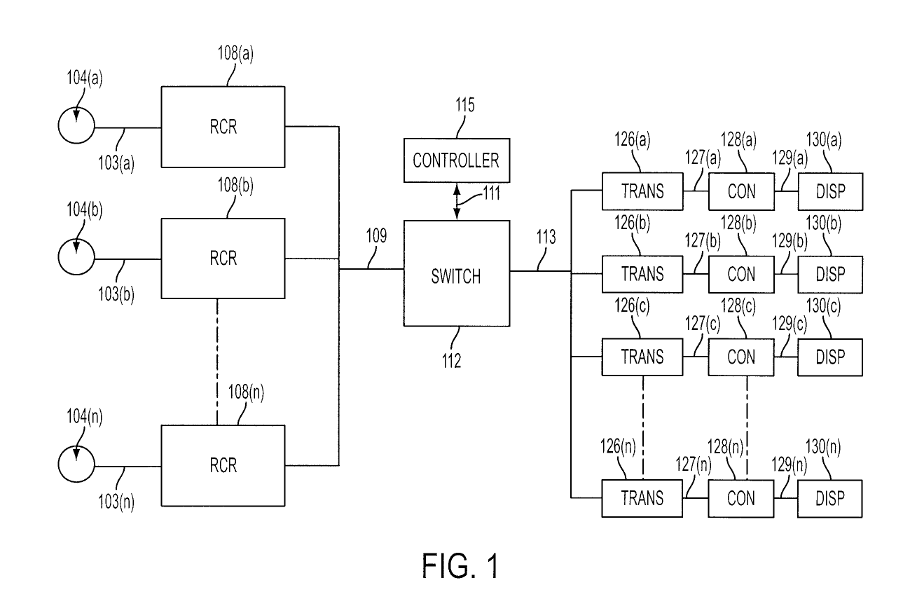

FIG. 1 shows a block diagram of the present invention. As shown in FIG. 1, a plurality of receiver devices 108(a) . . . (n) (where n is any suitable number) are coupled to a switching module 112, via interconnection medium 109, which may be PCB traces or other connection medium. Switch 112 is coupled to a control module 115, via PCB traces or other interconnection medium 111. The switching module 112 is coupled to a plurality of transmitter modules 126(a) . . . (n) (where n is any suitable number), via interconnection medium 113. Each transmitter module 126 (a) . . . (n) is connected to an associated output connector module 128(a) . . . (n) via an associated serial digital video connection medium, such as PCB traces, 127(a) . . . (n). Similarly, serial video digital connection medium 129(a) . . . (n), such as a DVI cable, may be used to connect an associated output connector module 128(a) . . . (n) to an associated display module 130(a) . . . (n). Also shown in FIG. 1 are serial digital video interconnector medium 103(a) . . . (n), which provide a communication path between connectors 104(a) . . . (n) and receiver devices 108(a) . . . (n), respectively.

The receiver devices, or receiver modules 108(a) . . . (n) (generally referred to as 108 herein) each have an associated connector 104(a) . . . (n) (generally referred to as 104 herein), such as, for example, a digital visual interface (DVI) connector. Digital video data is accessed by the receiver module 108 via associated connector 104. For example, connector 104 could be a wireless receiver capable of receiving a wireless signal. The accessed digital video data is transmitted to switching module 112 via PCB traces or other communication medium 109. A control module 115 is operatively coupled to switching module 112, via a communication medium 111. The switching module 112 performs a switching function to determine transmission of the digital video data to one or more transmitter modules 126(a) . . . (n) (generally referred to as 126 herein), via connection medium 113. Each transmitter module 126 is operatively coupled to an associated output connector 128(a) . . . (n), such as a DVI output connector (for example, output connector 128 could be a wireless transmitter capable of transmitting a wireless signal), which may be connected, either via a wired or wireless connection, to an associated display module, display device, monitor, monitor having a GUI or other display device 130(a) . . . (n), where “n” is any suitable number. The display modules 130 may also be operatively coupled to a computer or processing device (not shown) that has processing and storage capabilities to enhance the operation of display modules 130. For example, the display modules 130 may be the monitor of a computer that has a CPU, memory mouse and keyboard.

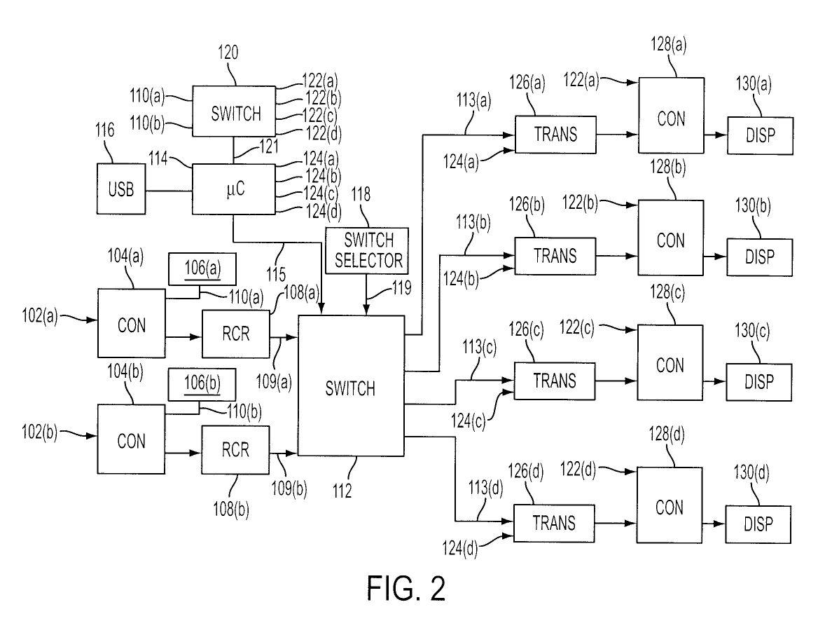

FIG. 2 illustrates one embodiment of the present invention. In this embodiment, the control module (generally shown as element 115 in FIG. 1) comprises a USB microcontroller 114 and switch selection module 118, which may be, for example, switch selection jumpers, an external switch, push buttons or rotary switch. As shown in FIG. 2, the apparatus comprises digital video inputs 102(a), 102(b) connected to DVI connectors 104(a) and 104(b), respectively. These connectors 104(a) and 104(b), which receive digital video data from the video inputs 102(a) and 102(b), are connected to associated DVI receiver modules, or receiver circuits, 108(a) and 108(b), respectively. These receiver circuits 108(a) and 108(b) may be, for example, a TFP 401 receiver circuit sold by Texas Instruments® or any other equivalent circuit that performs necessary reception of digital video data. Modules 106(a) and 106(b) are shadow EEPROMs of connectors 104(a) and 104(b) and signals 110(a) and 110(b) are bidirectional I²C signals for the transfer of DDC information of connectors 104(a) and 104(b). Bidirectional signals 110(a) and 110(b) are connected to switch unit 120, which is, for example, an I²C switch. The output from the receiver circuits 108(a) and 108(b) are connected via 109(a) and 109(b), respectively, to switch module 112 which may be, for example, a digital crossbar switch.

The switch unit 120, which may be, for example, an I²C switch, receives bidirectional I²C signals 110(a) and 110(b) from DVI connectors 104(a) and 104(b) and provides I²C signals 122(a) . . . (d) to display connectors 128(a) . . . (d), which are each coupled to an associated display device 130(a) . . . (d), respectively. The switch unit 120 connects one of 110(a) or 110(b) to one of 122(a) . . . (d) at a time. The switch unit 120 is also operatively coupled to microcontroller 114, via interconnector 121. Interconnector 121 may be, for example, an I²C bus. The apparatus further comprises switch selection module 118 which provides control signals, via interconnection medium 119, to switch module 112, which outputs digital video data signals, via interconnection media 113(a) . . . (d) to the display devices 130(a) . . . (d).

The apparatus may further comprise a USB interface 116 in conjunction with a controller, such as a USB microcontroller, 114. There is an option for manual selection using the switch selection module 118, however, the USB microcontroller 114 may be used to override the switch selection module 118 for ease in operation. The USB microcontroller 114 provides video enable signals 124(a)-124(d) to an associated transmitter circuit 126(a) . . . (d), respectively, which will be discussed in detail in the following paragraphs. The microcontroller 114 also provides control signals, via connection medium 115, to switch module 112. These control signals control the operation of switch module 112, overriding switch selection module 118, thereby determining what digital video signals are selected by the switch module 112 and transmitted to the display units 130(a) . . . (d).

The outputs 113(a) . . . (d) from switch module 112 are connected to DVI transmitter circuits 126(a)-126(d), respectively. The DVI transmitters 126(a)-126(d) also receive the signals 124(a)-124(d) from the USB microcontroller 114. The transmitters 126(a)-126(d) are operatively connected to DVI Output connectors 128(a)-128(d), which are directly connected to output monitors, display devices, or output modules 130(a)-130(d), respectively. The output modules 130(a) . . . (d) are typically monitors or displays, such as CRT, plasma or LCD displays adapted to display electronic data in readable or graphical form.

The DVI output connectors 128(a)-128(d) also receive signals 122(a)-122(d), respectively, from the switch 120, shown as an I²C switch. One of 110(a) or 110(b) is connected to one of 122(a) . . . (d) at a time. The pin configuration described herein may be changed according to the desired configuration and is therefore not confined to the description herein. Therefore, output monitors 130(a)-130(d) or display devices may display images or digital video signals 102(a) and 102(b) in any permutation and combination of these signals.

The digital video input 102(a) may be displayed at monitor devices 130(a), 130(b), 130(c) and 130(d) or any combination of those devices. Also, digital video data 102(b) may be displayed at any or all of the display devices 130(a) . . . (d). Thus, the video data 102(a) and 102(b) may each be displayed at one or more of the display devices 130(a) . . . (d). For example. video data 102(a) may be displayed at display devices 130(a) and 130(b) while video data 102(b) may be displayed at display devices 130(c) and 130(d). Alternatively video data 102(a) may be displayed at devices 130(a), 130(b) and 130(c) while video data 102(b) may be displayed at display devices 130(d). Other configurations and permutations of displaying data are also within embodiments of the present invention. It is also an embodiment of the present invention that when both a microcontroller 114 and a switch selection module 118 are used, control signals from the microcontroller 114 may override control signals from the switch selection module 118.

The following use scenario illustrates an operation of the embodiment of FIG. 2. The following example is illustrative only, and is not intended to limit the scope of the present invention. For example, presume a user wishes to display first video input 102(a) from a first computer on a first monitor 130(a) (located in an operating room) and a second monitor 130(b) (located in a training room). Simultaneously, the user wants to display second video input 102(b) from a second computer on a third monitor 130(c) and a fourth monitor 130(d). The user first connects the DVI output from the first computer into the DVI input 104(a) of the digital crosspoint switch in accordance with an embodiment of the present invention. Next, the user connects the DVI output from the second computer into the DVI input 104(b) of the digital crosspoint switch, or switching module, 112. Next, the user connects the DVI input connectors of the four monitors 130(a) . . . 103(d) to the DVI output connectors 128(a) . . . 128(d) of the digital crosspoint switch 112.

The user then selects which computer outputs he or she wants to display on which monitors. This can be accomplished either manually by setting the switch selection module 118 on the digital crosspoint switch 112, or by a Graphical User Interface (GUI) coupled to the USB controller 114 (GUI not shown). The user connects the USB cable 116 to one of the two computers which he or she wants to use to control the digital crosspoint switch, and selects which computers output to which displays by operating the GUI. The GUI sends control signals, through the USB cable 116, to USB microcontroller 114, which provides appropriate video enable signals 124(a) . . . 124(d) to DVI transmitters 126(a) . . . 126(d) and control signals, via interconnector 115, to switch module 112. In the above example, all four video enable signals 124(a) . . . 124(d) would be positive since the user wants all four monitors enabled. The user can disable one of the monitors by operating a GUI which sends a USB control signal that disables one of the monitors.

Shadow EEPROMs 122(a) . . . (d) are pre-programmed to support the basic resolutions that most monitors 130(a) . . . (d) will support. This will allow different graphics card to power up and display digital video data. If additional capability is provided by the connected monitor 130(a) . . . (d) and/or it is desired to have the actual DDC EEPROM in the shadow EEPROMs, the micro controller 114 can be instructed via USB 116 to copy the DDC EEPROM 124(a) . . . (d) of any monitor to the shadow EEPROMs 122(a) . . . (d). The shadow EEPROM can also be programmed from a file from the computer connected via USB or with default values directly from the microcontroller. Because of the operation of the I²C switch 120, each computer can be given access to each monitor's DDC EEPROM (one computer to one monitor at a time). It is not necessary that all the monitors that receive the same video must support the same video resolutions but they must all support the resolution that will be used.

Finally, the operation of the digital crosspoint switch is complete when the digital crossbar switch 112 receives the digital video data from the receivers 108(a) . . . 108(b), via interconnectors 109(a) and 109(b), connected to the input connectors 104(a) . . . 104(b) and receives the control signals from the USB microcontroller 114 or the switch selection module 118 and outputs digital video data signals. These output signals are provided to the appropriate transmitters 126(a) . . . 126(d) and DVI output connectors 128(a) . . . 128(d), via interconnectors 113(a) . . . (d). The DVI output connectors 128(a) . . . 128(d) are connected via DVI cables to associated display monitors 130(a) . . . 130(d). In the preceding example, the first input signal 102(a) is switched by switch 112 and displayed on first monitor 130(a) as well as second monitor 130(b), while the second input signal 102(b) is switched by switch 112 and displayed on third monitor 130(c) as well as fourth monitor 130(d).

This completes an example of a mode of operation of the embodiment illustrated in FIG. 2. The preceding example was illustrative of but one of many numerous ways in which the present invention may be used, and is not intended to limit the scope or spirit of the present invention in any way.

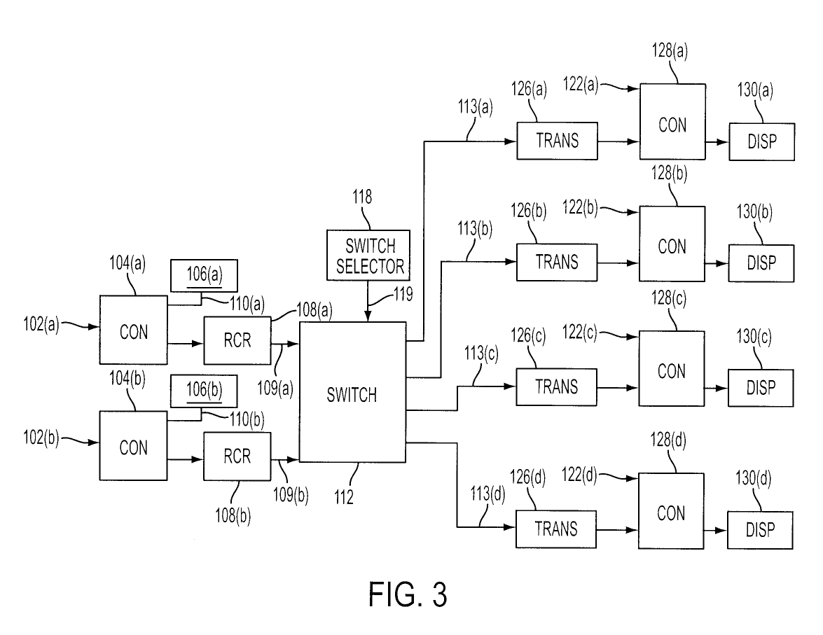

FIG. 3 illustrates an apparatus according to another embodiment of the present invention, wherein the control module comprises a switch selection module 118. The embodiment shown in FIG. 3 is similar to the embodiment shown in FIG. 2 with the exception that the I²C switch 120, USB connector 116 and the USB microcontroller 114 are omitted and the switching control functionality is accomplished by the switch selection module 118. The other components of FIG. 3 have been described in relation to FIG. 2 herein.

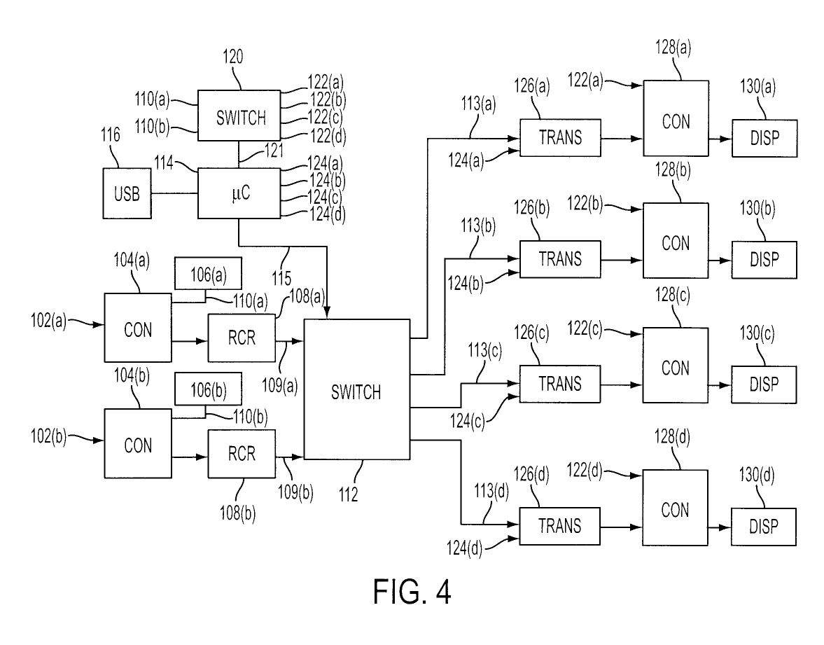

FIG. 4 illustrates an apparatus according to yet another embodiment of the present invention, wherein the control module comprises a USB microcontroller. The embodiment shown in FIG. 4 is similar to the embodiment shown in FIG. 2 with the exception that the switch selection module 118 has been omitted and the switching control function is performed by the USB microcontroller 114, which is connected via USB connector 116 to a computer, or processor, which provides control inputs to the USB microcontroller 114. The other components of FIG. 4 have been described in relation to FIG. 2 herein. Without the USB microcontroller there is no way to program the shadow EEPROMs and therefore, whatever is preprogrammed in them is the information that is used.

The above example of crosspoint/crossbar switches is meant to be illustrative only, and is not in any way intended to limit the scope or spirit of the present invention. One of ordinary skill in the art will recognize many numerous alternative implementations and embodiments of a crosspoint switch, or a crossbar switch, or another switching device. The switching devices, or modules, as used in embodiments of the present invention are in no way limited to the precise crosspoint/crossbar switches described here.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope and spirit of the invention as defined by the appended claims.

What is claimed is:

1. An apparatus, comprising:
one or more input modules adapted to receive digital video data signals;
a control module adapted to generate control signals;
a switching module adapted to receive the digital video data signals from the one or more input modules and the control signals from the control module and the switching module adapted to output digital video data signals; and
two or more output modules adapted to output digital video data from the one or more input modules as a function of the output digital video data signals.

2. The apparatus according to claim 1, wherein the control module comprises a microcontroller.

3. The apparatus according to claim 2, further comprising:
one or more serial buses coupled to the microcontroller and the output modules to provide communication between the microcontroller and the output modules.

4. The apparatus according to claim 2, wherein the microcontroller generates video enable signals and provides the video enable signals to selected output modules.

5. The apparatus according to claim 1, wherein the control module comprises switch selection module.

6. The apparatus according to claim 1, wherein selected digital video data is transmitted to any permutation of the output modules.

7. The apparatus according to claim 1, wherein the control module comprises a switch selection module and a microcontroller.

8. The apparatus according to claim 7, wherein the microcontroller overrides the switch selection module.

9. A method, comprising:
receiving digital video data input from one or more sources;
generating control signals;
selecting digital video data as a function of the received digital video data and the control signals; and
outputting digital video data, at two or more output locations, as a function of the selecting step.

10. The method according to claim 9, further comprising:
generating video enable signals; and
providing the video enable signals to selected output locations.

11. The method according to claim 9, further comprising:
transmitting digital video data to any permutation of the output locations.

12. An apparatus, comprising:
means for receiving digital video data input from one or more sources;
means for generating control signals;
means for selecting digital video data as a function of the received digital video data and the control signals; and
means for outputting digital video data, at two or more output locations, as a function of the means for selecting.

13. The apparatus according to claim 12, wherein the means for generating control signals includes a microcontroller.

14. The apparatus according to claim 13, wherein the microcontroller generates video enable signals and provides the video enable signals to selected means for outputting.

15. The apparatus according to claim 12, wherein the means for generating control signals includes switch selection module.

16. The apparatus according to claim 12, wherein selected digital video data is transmitted to any permutation of the means for outputting.

17. The apparatus according to claim 12, wherein the means for controlling includes switch selection module and a microcontroller.

18. The apparatus according to claim 17, wherein the microcontroller overrides the switch selection module.
